(19) United States
(12) Patent Application Publication
(10) Pub. No.: US 2026/0238748 A1
(43) Pub. Date: Aug. 13, 2026

(54) STEREOSCOPIC CAMERA DEVICE

(71) Applicant: Acer Incorporated, New Taipei City (TW)

(72) Inventors: Tsung-Wei Tu, New Taipei City (TW); Yi-Jung Chiu, New Taipei City (TW)

(73) Assignee: Acer Incorporated, New Taipei City (TW)

(21) Appl. No.: 19/260,605

(22) Filed: Jul. 6, 2025

(30) Foreign Application Priority Data
Feb. 12, 2025 (TW) 114105122

(51) Int. Cl. H04N 13/239; H04N 13/139

(52) U.S. Cl. CPC H04N 13/239; H04N 13/139

(57) ABSTRACT

A stereoscopic camera device adapted to signally connect to a stereoscopic display to display a stereoscopic image on the stereoscopic display. The stereoscopic camera device includes a first camera, a second camera and a processor. The first camera is configured to shoot towards an object to obtain a first image of the object. The second camera is configured to shoot towards the object to obtain a second image of the object. The processor is electrically connected to the first camera and the second camera. The processor crops the first image and the second image or scales the first image and the second image according to a specification of the stereoscopic display to output a processed first image and a processed second image so that a size of a part corresponding to the object in the stereoscopic image displayed on the stereoscopic display is in a specific proportion to a size of the object.

### CROSS-REFERENCE TO RELATED APPLICATION

This application claims the priority benefit of Taiwan application serial no. 114105122, filed on Feb. 12, 2025. The entirety of the above-mentioned patent application is hereby incorporated by reference herein and made a part of this specification.

### BACKGROUND

### Technical Field

The invention relates to a camera device, and particularly relates to a stereoscopic camera device.

### Description of Related Art

Generally, a display passively receives an image from a signal source and directly scales and displays the image on the display according to a resolution of the display. However, it has a substantial application requirement in the display field to enable an object in the image displayed on the display to have a specific proportion with the object itself, such as a proportion of 1:1.

In order to achieve the above-mentioned requirement of the specific proportion, a camera device needs to use a wide-angle and telephoto lens to narrow a field of view during shooting. However, when applied to a stereoscopic display, a size of an image on the display varies along with a viewing distance of a user. Therefore, there is difficulty in selecting a focal length or a field of view when shooting a stereoscopic image.

### SUMMARY

The invention is directed to a stereoscopic camera device, which is adapted to make a size of a part corresponding to an object in a stereoscopic image displayed on a stereoscopic display to be in a specific proportion to a size of the object.

An embodiment of the invention provides a stereoscopic camera device adapted to be signally connected to a stereoscopic display to display a stereoscopic image on the stereoscopic display. The stereoscopic camera device includes a first camera, a second camera and a processor. The first camera is configured to shoot towards an object to obtain a first image of the object. The second camera is configured to shoot towards the object to obtain a second image of the object. The processor is electrically connected to the first camera and the second camera. The processor crops the first image and the second image or scales the first image and the second image according to a specification of the stereoscopic display to output a processed first image and a processed second image so that a size of a part corresponding to the object in the stereoscopic image displayed on the stereoscopic display is in a specific proportion to a size of the object.

Based on the above description, in an embodiment of the invention, the stereoscopic camera device includes the first camera, the second camera and the processor. The processor is adapted to crop or scale the first image and the second image according to the specification of the stereoscopic display to output the processed first image and the processed second image so that the size of a part corresponding to the object in the stereoscopic image displayed on the stereoscopic display is in the specific proportion to the size of the object. Therefore, the stereoscopic camera device of the embodiment of the invention is adapted to simply make the stereoscopic image displayed on the stereoscopic display to have a specific proportion.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic diagram of a stereoscopic camera device according to an embodiment of the invention.

FIG. 2 is a schematic diagram illustrating a situation that a stereoscopic camera device crops or scales a first image and a second image according to an embodiment of the invention.

FIG. 3 is a schematic diagram showing a human eye viewing a stereoscopic display.

FIG. 4 is a schematic diagram showing existence of a vergence-accommodation conflict (VAC) when the human eye views the stereoscopic display.

FIG. 5A is a schematic diagram of a stereoscopic camera device shifting and cropping a first image and a second image according to an embodiment of the invention.

FIG. 5B is a schematic diagram of synthesizing/superimposing the shifted and cropped first image and second image in FIG. 5A.

FIG. 6 is a schematic diagram showing a relationship between parameters such as a baseline, a distance between an object and the baseline, and focal lengths of a first camera and a second camera according to a stereoscopic camera device of another embodiment of the invention.

### DESCRIPTION OF THE EMBODIMENTS

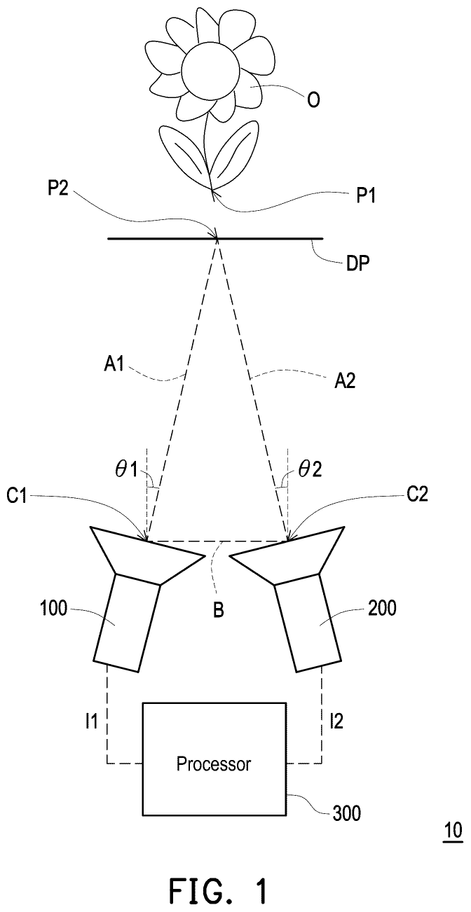

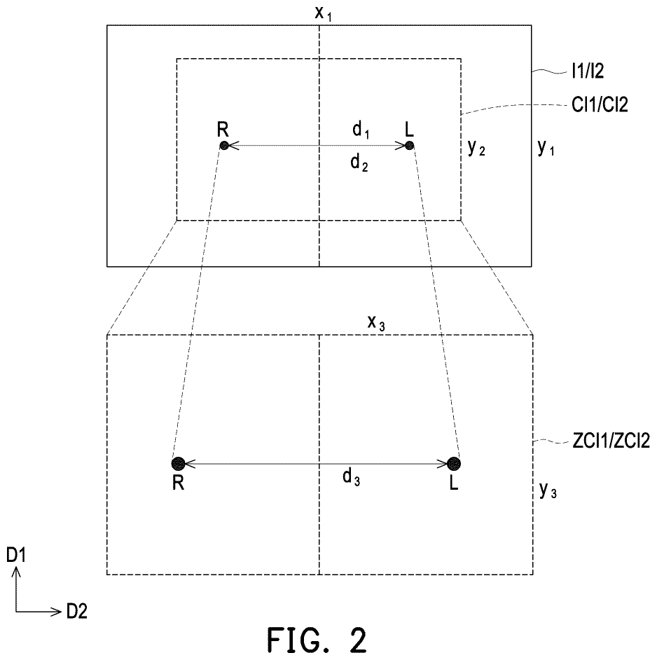

FIG. 1 is a schematic diagram of a stereoscopic camera device according to an embodiment of the invention. FIG. 2 is a schematic diagram illustrating a situation that the stereoscopic camera device crops or scales a first image and a second image according to an embodiment of the invention.

Referring to FIG. 1 and FIG. 2, an embodiment of the invention provides a stereoscopic camera device 10 adapted to be signally connected to a stereoscopic display to display stereoscopic images on the stereoscopic display. The stereoscopic camera device 10 includes a first camera 100, a second camera 200, and a processor 300. The first camera 100 is configured to shoot towards an object O to obtain a first image I1 of the object O. The second camera 200 is configured to shoot towards the object O to obtain a second image 12 of the object O. The processor 300 is electrically connected to the first camera 100 and the second camera 200. The processor 300 crops the first image I1 and the second image 12 or scales the first image I1 and the second image 12 according to a specification of the stereoscopic display to output a processed first image ZCI1 and a processed second image ZCI2, so that a size of a part corresponding to the object O in a stereoscopic image displayed on the stereoscopic display is in a specific proportion to a size of the object O. The specific proportion is, for example, 1:1, but the invention is not limited thereto.

In detail, the first camera 100 and the second camera 200 may be complementary metal-oxide semiconductor (CMOS) cameras or charge coupled device (CCD) cameras, but the invention is not limited thereto.

In the embodiment, the processor 300 includes, for example, a microcontroller unit (MCU), a central processing unit (CPU), a microprocessor (microprocessor), a digital signal processor (DSP), a programmable controller, a programmable logic device (PLD), or other similar devices or a combination of these devices, but the invention is not limited thereto. In addition, in an embodiment, each function of the processor 300 may be implemented as a plurality of program codes. These program codes are stored in a memory and executed by the processor 300. Alternatively, in an embodiment, each function of the processor 300 may be implemented as one or a plurality of circuits. The invention does not limit the implementation of various functions of the processor 300 through software or hardware.

In FIG. 1, the first camera 100 and the second camera 200 shoot towards the object O, and an optical axis A1 of the first camera 100 and an optical axis A2 of the second camera 200 respectively have toe-in angles θ1 and θ2. An intersection point (i.e., a focus position) P2 of the optical axis A1 of the first camera 100 and the optical axis A2 of the second camera 200 defines a display plane DP of the stereoscopic display. A straight line formed between the first camera 100 and the second camera 200 is defined as a baseline B, and the display plane DP is parallel to the baseline B.

When a position P1 of the object O is behind the display plane DP (the display plane DP is located between the position P1 and the baseline B), the stereoscopic image displayed on the stereoscopic display has an effect of being sunken into the stereoscopic display. On the contrary, when the position P1 of the object O is in front of the display plane DP (the position P1 is located between the display plane DP and the baseline B), the stereoscopic image displayed on the stereoscopic display has an effect of floating out of the stereoscopic display.

In FIG. 2, an imaging position of the object O photographed by the first camera 100 falls at a position L of the first image I1, and an imaging position of the object O photographed by the second camera 200 falls at a position R of the second image 12. An upper part of FIG. 2 shows an image obtained by synthesizing/superimposing the first image I1 and the second image 12, and an image obtained by synthesizing/superimposing the cropped first image CI1 and the cropped second image CI2. A lower part of FIG. 2 shows an image obtained by synthesizing/superimposing the cropped and scaled first image (i.e., the processed first image) ZCI1 and the cropped and scaled second image (i.e., the processed second image) ZCI2. In addition, when the first image I1 and the second image 12 are cropped, image contents within cropping ranges are retained and contents outside the cropping ranges are deleted, thereby generating the cropped first image CI1 and the cropped second image CI2.

In the embodiment, cropping ratios of the processed first image ZCI1 and the processed second image ZCI2 relative to the first image I1 and the second image 12 satisfy following expressions (1):

$${t}_{y 1} = \frac{2 \cdot VD \cdot tan ( \frac{VFoV}{2} )}{PSD \cdot VRD} , \qquad ( 1 )$$

$${t}_{x 1} = \frac{2 \cdot VD \cdot cot ( \frac{HFoV}{2} )}{PSD \cdot HRD}$$

Where, t_{y1} is a cropping ratio in a vertical direction D1, tₓ₁ is a cropping ratio in a horizontal direction D2, VD is a viewing distance of the stereoscopic display, VFoV is a field of view of the first camera 100 and the second camera 200 in the vertical direction D1, HFoV is a field of view of the first camera 100 and the second camera 200 in the horizontal direction D2, PSD is a size of each pixel of the stereoscopic display (generally, the pixel has an equal size in the horizontal direction and the vertical direction), VRD is a pixel number of the stereoscopic display in the vertical direction D1, and HRD is a pixel number of the stereoscopic display in the horizontal direction D2.

In the embodiment, scaling ratios of the processed first image ZCI1 and the processed second image ZCI2 relative to the first image I1 and the second image 12 satisfy following expressions (2) and (3):

$${t}_{y 2} = \frac{{y}_{3}}{{y}_{2}} , \qquad ( 2 )$$

$${t}_{x 2} = \frac{{x}_{3}}{{x}_{2}}$$

$${t}_{y 1} = \frac{{y}_{1}}{{y}_{2}} , \qquad ( 3 )$$

$${t}_{x 1} = \frac{{x}_{1}}{{x}_{2}}$$

Where, t_{y2} is a scaling ratio in the vertical direction D1, tₓ₂ is a scaling ratio in the horizontal direction D2, y₁ is a size of the first image I1 and the second image 12 in the vertical direction D1, x₁ is a size of the first image I1 and the second image 12 in the horizontal direction D2, y₂ is a size of a cropped first image CI1 and second image CI2 in the vertical direction D1, x₂ is a size of the cropped first image CI1 and second image CI2 in the horizontal direction D2, y₃ is a size of a cropped and scaled first image ZCI1 and second image ZCI2 in the vertical direction D1, and x₃ is a size of the cropped and scaled first image I1 and second image 12 in the horizontal direction D2.

Taking a 15.6-inch 4K resolution stereoscopic display as an example, a width of the display plane DP of the stereoscopic display may be 344.2176 mm, and the pixel number HRD of the stereoscopic display in the horizontal direction D2 may be 3840. Therefore, a size PSD of each pixel of the stereoscopic display may be 344.2176/3840=0.08964 mm/pixel. In addition, the field of view VFoV of the stereoscopic display in the vertical direction D1 may be 60.1 degrees, and the pixel number VRD of the stereoscopic display in the vertical direction D1 may be 2160. Considering that the viewing distance VD is 600 mm, the cropping rate t_{y1}=3.585 in the vertical direction D1 may be obtained from the above expression (1).

Moreover, in the embodiment, the cropped first image CI1 and the cropped second image CI2 satisfy a following expression (4):

$${d}_{2} = {d}_{1} \qquad ( 4 )$$

Where, d₁ is a disparity between the first image I1 and the second image 12, and d₂ is a disparity between the cropped first image CI1 and the cropped second image CI2. When the disparity is 0, a position of the stereoscopic image falls on the display plane DP of the stereoscopic display. When the disparity is positive, the stereoscopic image has the effect of being sunken into the stereoscopic display. On the contrary, when the disparity is negative, the stereoscopic image has the effect of floating out of the stereoscopic display.

In the embodiment, the processed first image ZCI1 and second image ZCI2 satisfy a following expression (5):

$${d}_{3} = {t}_{x 2} \cdot {d}_{1} = \frac{{x}_{3}}{{x}_{2}} \cdot {d}_{1} \qquad ( 5 )$$

Where, d₃ is a disparity between the processed first image ZCI1 and second image ZCI2 (or a disparity between the cropped and scaled first image ZCI1 and second image ZCI2 in the horizontal direction D2).

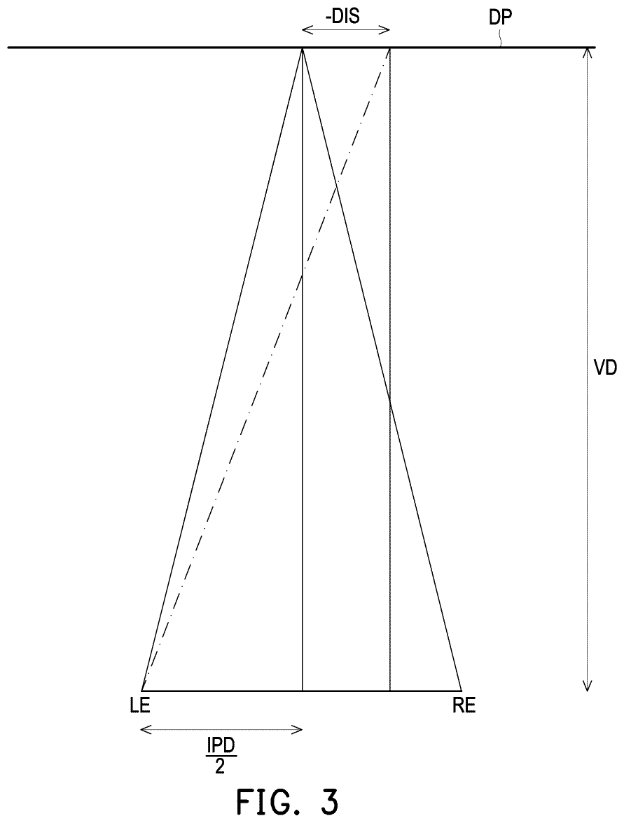

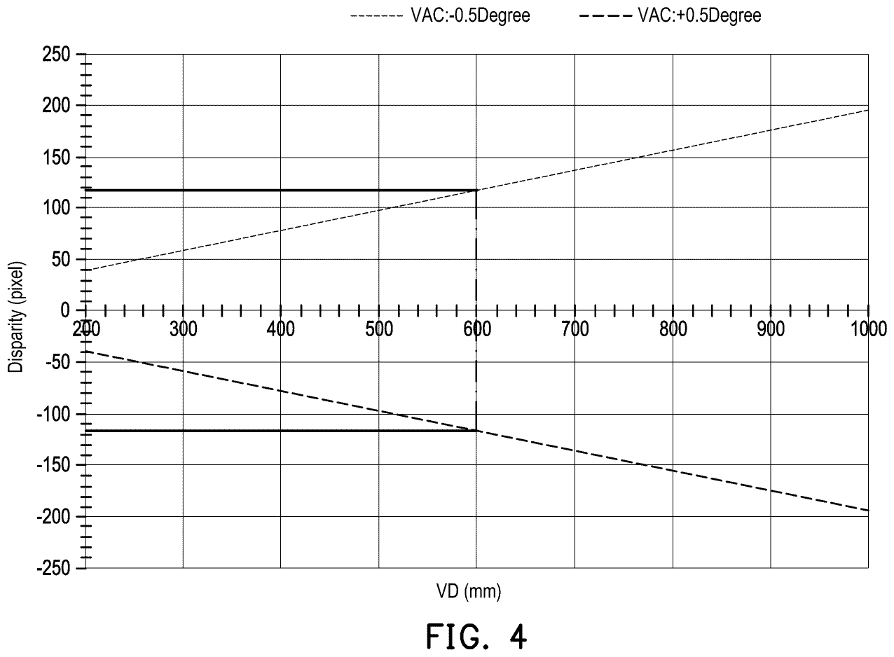

FIG. 3 is a schematic diagram showing a human eye viewing a stereoscopic display. FIG. 4 is a schematic diagram showing existence of a vergence-accommodation conflict (VAC) when the human eye views the stereoscopic display. In FIG. 3, FIG. 3 shows that an intersection point of sight lines of a left eye LE and a right eye RE of a viewer falls on the display plane DP, where a pupil distance between the left eye LE and the right eye RE is IPD. Considering a difference VAC between human eye accommodation and vergence in expression (6):

$$VAC = {tan}^{- 1} ( \frac{- \frac{1}{2} D I S}{VD} ) \qquad ( 6 )$$

Where, DIS is the disparity. When the difference VAC falls within a range of ±0.5 degrees, discomfort felt by viewers when watching stereoscopic images may be reduced.

FIG. 4 is a curve diagram of each viewing distance VD relative to disparity for a 15.6-inch stereoscopic display when the differences VAC are within ±0.5 degrees. In FIG. 4, when the viewing distance VD is 600 mm, the condition that the above VAC falls within the range of ±0.5 degrees corresponds to a range of the disparity of ±10.48788 mm or ±117 pixels (as the PSD is 0.08964 mm/pixel). Namely, FIG. 2 illustrates that the disparity d₃ between the processed first image ZCI1 and the processed second image ZCI2 is greater than the disparity d₁ between the first image I1 and the second image 12 (but the invention is not limited thereto). However, when the disparity d₃ does not satisfy −117 pixels≤d₃≤+117 pixels (i.e., a following expression (10)), the system preferably reduces the disparity to reduce the discomfort of the viewers when viewing the stereoscopic images.

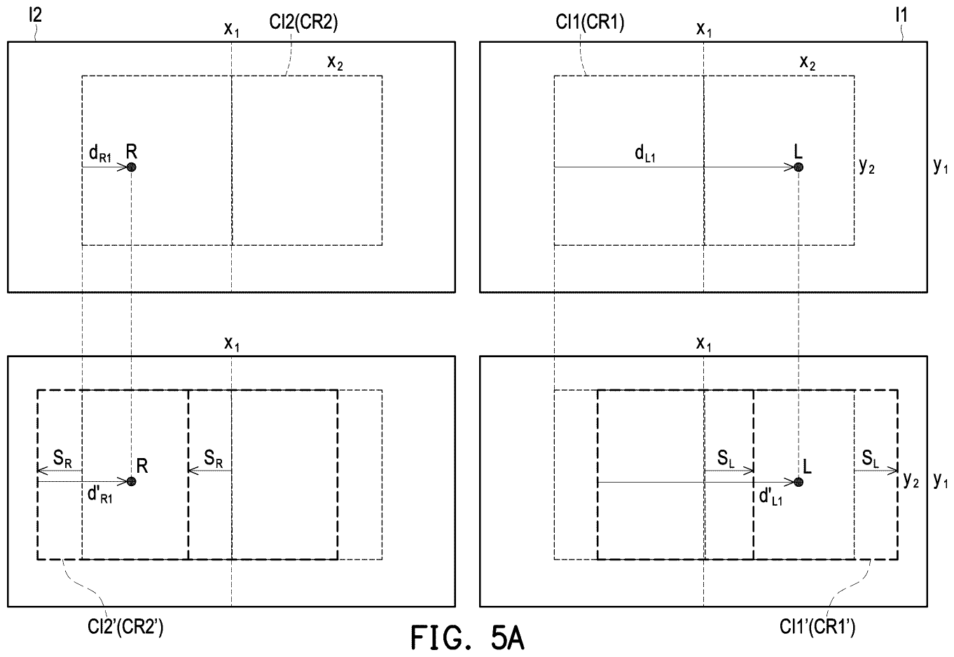

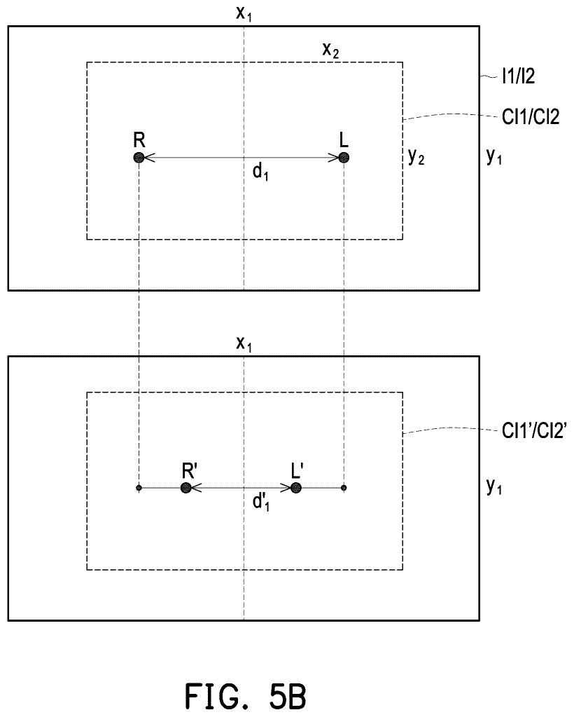

FIG. 5A is a schematic diagram of a stereoscopic camera device shifting and cropping a first image and a second image according to an embodiment of the invention. FIG. 5B is a schematic diagram of synthesizing/superimposing the shifted and cropped first image and second image in FIG. 5A.

Referring to FIG. 3 to FIG. 5B, in the embodiment, when an absolute value of d₃ is greater than a comfortable disparity value, the processor 300 shifts cropping ranges CR1 and CR2 of the first image I1 and the second image 12 along the horizontal direction D2 (to form cropping ranges CR1′ and CR2′) according to a cropping shifting value, so as to obtain shifted and cropped first image CI1′ and second image CI2′, and then the processor 300 scales the shifted and cropped first image CI1′ and second image CI2′ according to scaling ratios t_{y2} and tₓ₂ to generate the processed first image and second image. A lower part of FIG. 5B shows an image obtained by synthesizing/superimposing the shifted and cropped first image CI1 and second image CI2′. Compared to the image obtained by synthesizing/superimposing the first image I1 and the second image 12 in the upper part of FIG. 5B, an absolute value of the disparity d′₁ (i.e., the difference between the positions L′ and R′) in the lower part of FIG. 5B is smaller than an absolute value of the disparity d₁ in the upper part of FIG. 5B.

In the embodiment, a shift direction of the cropping range of the first image I1 is opposite to a shift direction of the cropping range of the second image 12 (as shown in a following expression (12)).

In the embodiment, following expressions (7) and (8) may be obtained according to relative relationships between distances d_{L1}, d′_{L1}, d_{R1}, and d′_{R1} in FIG. 5A:

$${d}_{1} = {d}_{R 1} - {d}_{L 1} \qquad ( 7 )$$

$${d}_{1}^{′} - {d}_{R 1}^{′} - {d}_{L 1}^{′} = ( {d}_{R 1} - {S}_{R} ) - ( {d}_{L 1} - {S}_{L} ) = {d}_{1} - ( {S}_{R} - {S}_{L} ) \qquad ( 8 )$$

Where, S_{L} and S_{R} are respectively cropping shifting values of the first image I1 and the second image 12 under shifting and cropping. Moreover, in FIG. 5A, S_{R}>0, and S_{L}<0.

In the embodiment, a following expression (11) may be obtained according to expressions (9) and (10):

$${d}_{3} = \frac{{x}_{3}}{{x}_{2}} \cdot {d}_{1}^{′} \qquad ( 9 )$$

$$\vert {d}_{3} \vert \leq \vert CD \vert \qquad ( 10 )$$

$$\vert {d}_{1}^{′} \vert = \vert {d}_{1} - ( {S}_{R} - {S}_{L} ) \leq \vert \frac{{x}_{2}}{{x}_{3}} \cdot CD \vert \qquad ( 11 )$$

Where, CD is a comfortable disparity value (for example, ±117 pixels in FIG. 4). Considering a following expression (12), the cropping shifting value satisfies a following expression (13):

$${S}_{R} = - {S}_{L} = S \qquad ( 12 )$$

$$S \geq \frac{\vert \frac{{x}_{2}}{{x}_{3}} \cdot CD \vert - {d}_{1}}{2} \qquad ( 13 )$$

Where, S is the cropping shifting value.

Namely, the above FIG. 2 illustrates that the disparity d₃ of the first image I1 and the second image 12 after being cropped and scaled is greater than the disparity d₁ of the original first image I1 and the second image 12. When the disparity d₃ satisfies the above expression (10), the stereoscopic camera device 10 may directly output the cropped and scaled first image ZCI1 and the cropped and scaled second image ZCI2. On the contrary, when the disparity d₃ does not satisfy the above expression (10), the stereoscopic camera device 10 may generate the processed first image and the second image by scaling the first image and the second image after shifting and cropping the same as shown in FIG. 5A and FIG. 5B. Therefore, the stereoscopic camera device 10 may reduce the discomfort felt by viewers when viewing stereoscopic images.

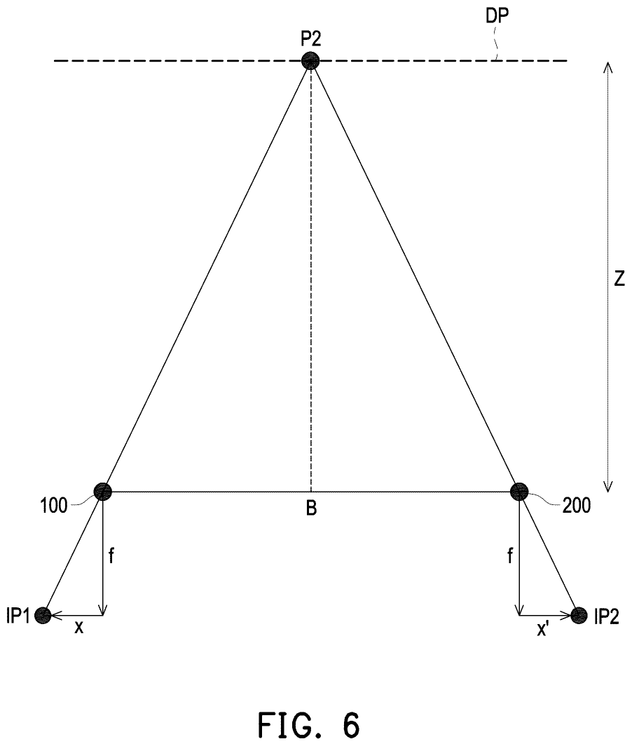

FIG. 6 is a schematic diagram showing a relationship between parameters such as a baseline, a distance between an object and the baseline, and focal lengths of a first camera and a second camera according to a stereoscopic camera device of another embodiment of the invention.

Referring to FIG. 6, in the embodiment, when the absolute value of d₃ is greater than the comfortable disparity value CD, the processor 300 adjusts a length BL of the baseline B between the first camera 100 and the second camera 200 to reduce a disparity between the first image I1 and the second image 12. For example, the stereoscopic camera device further includes actuators, which are respectively connected to the first camera 100 and the second camera 200, and are electrically connected to the processor 300. The actuators are configured to change a toe-in angle θ1 of an optical axis A1 and a position C1 of the first camera 100, and change a toe-in angle θ2 of an optical axis A2 and a position C2 of the second camera 200.

In detail, the first camera 100 and the second camera 200 shoot towards a position P2, the object O is imaged at an imaging point IP1 at the first camera 100, and the object O is imaged at an imaging point IP2 at the second camera 200. Therefore, the disparity of the stereoscopic image satisfies a following expression (14):

$$( x - {x}^{′} ) = \frac{f \cdot BL}{Z} \qquad ( 14 )$$

Where, x is a distance between the imaging point IP1 and the optical axis of the first camera 100, x′ is a distance between the imaging point IP2 and the optical axis of the second camera 200, f is a focal length of the first camera 100 and the second camera 200 (for example, the first camera 100 and the second camera 200 respectively include a lens element and an imaging element, and f is a focal length of the lens element), and Z is a distance between the object O and the baseline B.

Due to following expressions (15) to (17):

$$( x - {x}^{′} ) = \frac{1}{{m}_{c}} {d}_{1} = \frac{f \cdot BL}{Z} \qquad ( 15 )$$

$$BL = \frac{Z}{{m}_{cf}} \cdot {d}_{1} \qquad ( 16 )$$

$$\vert {d}_{1} \vert \leq \vert CD \cdot \frac{{x}_{2}}{{x}_{3}} \vert \qquad ( 17 )$$

In the embodiment, the length BL of the baseline B between the first camera 100 and the second camera 200 satisfies a following expression (18):

$$BL \leq \frac{Z}{{m}_{cf}} \cdot CD \cdot \frac{{x}_{2}}{{x}_{3}} \qquad ( 18 )$$

Where, m_{c} is a size of each pixel of the first image I1 and the second image 12.

Namely, when shooting a stereoscopic image, the length BL of the baseline B between the first camera 100 and the second camera 200 is adjusted so that the absolute value of the disparity d₃ is smaller than the comfortable disparity value CD, thereby reducing the discomfort felt by viewers when watching the stereoscopic image.

In summary, in an embodiment of the invention, the stereoscopic camera device includes a first camera, a second camera and a processor. The first camera is configured to shoot towards an object to obtain a first image of the object. The second camera is configured to shoot towards the object to obtain a second image of the object. The processor crops the first image and the second image or scales the first image and the second image according to a specification of the stereoscopic display to output a processed first image and a processed second image so that a size of a part corresponding to the object in the stereoscopic image displayed on the stereoscopic display is in a specific proportion to a size of the object. Therefore, the stereoscopic camera device of the embodiment of the invention is adapted to simply make the stereoscopic image displayed on the stereoscopic display to have the specific proportion.

What is claimed is:

1. A stereoscopic camera device, adapted to be signally connected to a stereoscopic display to display a stereoscopic image on the stereoscopic display, the stereoscopic camera device comprising:
a first camera, configured to shoot towards an object to obtain a first image of the object;
a second camera, configured to shoot towards the object to obtain a second image of the object; and
a processor, electrically connected to the first camera and the second camera,
wherein the processor crops the first image and the second image or scales the first image and the second image according to a specification of the stereoscopic display to output a processed first image and a processed second image so that a size of a part corresponding to the object in the stereoscopic image displayed on the stereoscopic display is in a specific proportion to a size of the object.

2. The stereoscopic camera device as claimed in claim 1, wherein cropping ratios of the processed first image and the processed second image relative to the first image and the second image satisfy:
$${t}_{y 1} = \frac{2 \cdot VD \cdot tan ( \frac{VFoV}{2} )}{PSD \cdot VRD} ,$$
$${t}_{x 1} = \frac{2 \cdot VD \cdot cot ( \frac{HFoV}{2} )}{PSD \cdot HRD} ,$$
wherein t_{y1} is a cropping ratio in a vertical direction, tₓ₁ is a cropping ratio in a horizontal direction, VD is a viewing distance of the stereoscopic display, VFoV is a field of view of the first camera and the second camera in the vertical direction, HFoV is a field of view of the first camera and the second camera in the horizontal direction, PSD is a size of each pixel of the stereoscopic display, VRD is a pixel number of the stereoscopic display in the vertical direction, and HRD is a pixel number of the stereoscopic display in the horizontal direction.

3. The stereoscopic camera device as claimed in claim 2, wherein scaling ratios of the processed first image and the processed second image relative to the first image and the second image satisfy:
$${t}_{y 2} = \frac{{y}_{3}}{{y}_{2}} ,$$
$${t}_{x 2} = \frac{{x}_{3}}{{x}_{2}} ,$$
$${t}_{y 1} = \frac{{y}_{1}}{{y}_{2}} ,$$
$${t}_{x 1} = \frac{{x}_{1}}{{x}_{2}} ,$$
wherein t_{y2} is a scaling ratio in the vertical direction, tₓ₂ is a scaling ratio in the horizontal direction, y₁ is a size of the first image and the second image in the vertical direction, x₁ is a size of the first image and the second image in the horizontal direction, y₂ is a size of a cropped first image and a cropped second image in the vertical direction, x₂ is a size of the cropped first image and the cropped second image in the horizontal direction, y₃ is a size of a cropped and scaled first image and a cropped and scaled second image in the vertical direction, and x₃ is a size of the cropped and scaled first image and the cropped and scaled second image in the horizontal direction.

4. The stereoscopic camera device as claimed in claim 3, wherein the processed first image and the processed second image satisfy:
$${d}_{3} = {t}_{x 2} \cdot {d}_{1} = \frac{{x}_{3}}{{x}_{2}} \cdot {d}_{1} ,$$
d₁ is a disparity between the first image and the second image, and d₃ is a disparity between the processed first image and the processed second image.

5. The stereoscopic camera device as claimed in claim 4, wherein when an absolute value of d3 is greater than a comfortable disparity value, the processor shifts cropping ranges of the first image and the second image along the horizontal direction according to a cropping shifting value, so as to obtain a shifted and cropped first image and a shifted and cropped second image, and the processor scales the shifted and cropped first image and the shifted and cropped second image according to the scaling ratios to generate the processed first image and the processed second image.

6. The stereoscopic camera device as claimed in claim 5, wherein a shift direction of the cropping range of the first image is opposite to a shift direction of the cropping range of the second image.

7. The stereoscopic camera device as claimed in claim 5, wherein the cropping shifting value satisfies:
$$S \geq \frac{\vert \frac{{x}_{2}}{{x}_{3}} \cdot CD \vert - {d}_{1}}{2} ,$$
wherein S is the cropping shifting value, and CD is the comfortable disparity value.

8. The stereoscopic camera device as claimed in claim 4, wherein when an absolute value of d₃ is greater than a comfortable disparity value, the processor adjusts a length of a baseline between the first camera and the second camera to reduce a disparity between the first image and the second image.

9. The stereoscopic camera device as claimed in claim 8, wherein the length of the baseline between the first camera and the second camera satisfies:
$$BL \leq \frac{Z}{{m}_{cf}} \cdot CD \cdot \frac{{x}_{2}}{{x}_{3}} ,$$
wherein BL is the length of the baseline, Z is a distance between the object and the baseline, m_{c} is a size of each pixel of the first image and the second image, f is a focal length of the first camera and the second camera, and CD is the comfortable disparity value.
